(19) United States
(12) Patent Application Publication
(10) Pub. No.: US 2014/0224417 A1
(43) Pub. Date: Aug. 14, 2014

(54) ORGANIC VEHICLE FOR DISPERSION OF GLASS COMPOSITION AND METHOD OF DISPERSION

(71) Applicant: Heraeus Precious Metals North America Conshohocken LLC, West Conshohocken, PA (US)

(72) Inventors: Samson Shahbazi, Roslyn, PA (US); Steven Grabey, Hazleton, PA (US); Mark Challingsworth, Glenside, PA (US)

(73) Assignee: Heraeus Precious Metals North America Conshohocken LLC, West Conshohocken, PA (US)

(21) Appl. No.: 14/175,536

(22) Filed: Feb. 7, 2014

Related U.S. Application Data
(60) Provisional application No. 61/763,674, filed on Feb. 12, 2013.

(51) Int. Cl. C03C 8/24

(52) U.S. Cl. CPC C03C 8/24
USPC 156/249; 501/15

(57) ABSTRACT

A sealing glass composition including about 30-95 wt % glass or ceramic particles, and about 1-50 wt % organic vehicle, wherein the organic vehicle comprises an acrylic resin component and a solvent, based upon 100% total weight of the sealing glass composition, wherein the composition has a viscosity of at least about 200 kcPs and no more than about 1450 kcPs, is provided. A method of applying a sealing glass composition to a substrate comprising the steps of providing a metal substrate, providing a supporting sheet having a front surface coated with a releasing agent, depositing a sealing glass composition onto the front surface of the releasable sheet, drying the sealing glass composition to form a sealing glass composition decal, removing the sealing glass composition decal from the front surface of the supporting sheet, and placing the dried sealing glass composition decal onto a metal substrate, is provided.

### TECHNICAL FIELD

The invention is directed to a sealing glass composition having glass or ceramic particles and an organic vehicle. The organic vehicle includes a solvent and an acrylic resin component, and preferably has a viscosity of at least about 200 kcPs and no more than about 1450 kcPs. In one application, the sealing glass composition may be used in the manufacture of fuel cell assemblies. The invention is also directed to a method of applying the sealing glass composition of the invention to an underlying substrate using a decal screen printing technique.

### BACKGROUND

Fuel cells are devices which produce electricity by oxidizing a fuel material. Fuel cells are categorized by their electrolyte composition. Electrolytes are materials which contain charged ions. Solid oxide fuel cells, or “SOFCs”, contain a solid oxide or ceramic electrolyte. SOFCs are advantageous because they are highly efficient, stable and inexpensive. However, they also operate under higher temperatures than other types of fuel cells, causing them to have various mechanical and chemical compatibility issues.

Generally, SOFCs are made up of various layers, which include ceramic materials. The ceramics become electrically and ionically active at very high temperatures (i.e., 500-1000° C.). Reduction of oxygen into oxygen ions occurs at these elevated temperatures in the cathode of the fuel cell. The ions diffuse through the electrolyte to the anode, where they electrochemically oxidize the fuel. Two electrons (as well as water) are given off as a byproduct. These electrons then flow through the external circuitry, thereby conducting electricity.

Fuel cells can be assembled in a variety of structures. In a planar design, the electrolyte material is sandwiched between the electrodes, and the structure is assembled in flat stacks. Sealing materials are applied between the stacks to prevent fuel and oxidant mixing, as well as to electrically insulate the fuel cell layers. Typically, glass materials are used in sealing compositions because they are highly electrically insulating and can provide a gas tight seal. To make it possible to disperse the glass or ceramic onto the fuel cell layers in the desired pattern, the glass is usually mixed with an organic vehicle. However, since the sealing glass is typically milled into fine particles, producing a sealing glass mixture with high solid content and which provides the desirable dispensing or printing characteristics is challenging.

An organic vehicle which optimizes the sealing composition such that it can be easily deposited onto the fuel cell layers or substrates using a decal transfer or syringe dispensing technique is desired. Further, an organic vehicle which provides the sealing glass composition with sufficient flexibility and durability in a dried or “green” state is also desired.

### SUMMARY

The invention provides a sealing glass composition including about 30-95 wt % glass or ceramic particles, and about 1-50 wt % organic vehicle including an acrylic resin component and a solvent, based upon 100% total weight of the sealing glass composition. The composition preferably has a viscosity of at least about 200 kcPs and no more than about 1450 kcPs. The sealing glass composition of the invention may be used in a decal transfer process for forming sealing layers in a fuel cell assembly. The sealing glass composition provides good flexibility and green strength for use in a decal transfer process.

The invention also provides a method of applying a sealing glass composition to a substrate comprising the steps of providing a supporting sheet having a front surface coated with a releasing agent, depositing a sealing glass composition onto the front surface of the supporting sheet according to a pre-determined pattern, drying the sealing glass composition to form a sealing glass composition decal, removing the sealing glass composition decal from the front surface of the supporting sheet, and placing the dried sealing glass composition decal onto a metal substrate. In one embodiment, the depositing of the sealing glass composition onto the supporting sheet is by screen printing.

Another aspect of the invention is an article including a plurality of metal substrate frames, a plurality of sealing glass layers, wherein each metal substrate frame is stacked on top of each sealing glass layer to form an alternating assembly, and m=s+1 and m≧2, wherein m equals the number of the metal substrate frames and s equals the number of sealing glass layers.

### BRIEF DESCRIPTION OF THE DRAWINGS

A more complete appreciation of the invention and many of the attendant advantages thereof will be readily obtained as the same becomes better understood with reference to the following detailed description when considered in connection with the accompanying drawings, wherein:

FIG. 1A is a top view of exemplary sealing glass paste printed in a pattern on a supporting sheet;

FIG. 1B is a cross section view of the exemplary sealing glass paste printed in a pattern on a supporting sheet as shown in FIG. 1A;

FIG. 2 is a cross-sectional view of illustrative stack of fuel cell layers and sealing glass composition; and

FIG. 3 illustrates a top view of an exemplary fuel cell layer mounted on a metal substrate with sealing glass composition dispensed according to a pattern on the metal substrate.

### DETAILED DESCRIPTION

The invention is directed to an organic vehicle composition for dispensing glass or ceramic particles. While not limited to such an application, such an organic vehicle may be incorporated into a sealing glass composition used in the formation of fuel cell structures. A desired vehicle for this application has certain characteristics that allow the sealing glass composition to be easily applied to the underlying substrate using a decal transferring or syringe dispensing method. Further, the organic vehicle provides the sealing glass composition with sufficient flexibility in its green state so that it can be peeled from a substrate, while also providing sufficient “green strength,” or durability before firing, so as to withstand peeling and/or handling without tearing or cracking.

### Organic Vehicle

One aspect of the invention is an organic vehicle for dispensing glass or ceramic particles. Glass or ceramic particles are useful in any number of electronic applications because of their insulative properties. To be able to apply these particles to the desired area of a substrate, they are usually mixed with an organic vehicle in order to “wet” the particles, forming a sealing glass composition, such that they can be applied to the underlying substrate.

According to one embodiment of the invention, the organic vehicle comprises an acrylic resin component and a solvent. The acrylic resin may be any substance derived from, for example, ethyl acrylate, methyl acrylate, butyl acrylate, 2-ethylhexyl acrylate, acrylic acid, methyl methacrylate, isobutyl methacrylate, ethyl methacrylate, n-butyl methacrylate, isobornyl methacrylate, t-butyl methacrylate, lauryl methacrylate, methacrylic acid, hydroxyethyl methacrylate, hydroxypropyl methacrylate, diethylaminoethyl methacrylate or other related compounds, including, but not limited to, esters of acrylic or methacrylic acid, or acrylonitrile. These compounds can chemically react with other monomers via the vinyl groups to form an acrylic resin. The acrylic resin may be a homo-polymer or a co-polymer of the above mentioned monomers.

The presence of the acrylic resin is preferred in that it provides the organic vehicle with the necessary viscosity to allow the organic vehicle to be incorporated into a sealing glass composition and for the composition to be deposited onto a fuel cell substrate. Further, in a decal transfer application process, the acrylic resin allows the printed or dispensed film of the sealing glass composition to retain its shape and flexibility when in its green state. This characteristic makes it possible for the printed sealing glass composition to be formed into a decal when dried, which may be lifted from a supporting sheet coated with a releasing agent. The acrylic resin also provides the printed decal with enough flexibility so as to be able to be peeled from the supporting sheet, while also having sufficient durability that it can be peeled and handled without tearing.

The organic vehicle preferably comprises at least about 0.1 wt % total acrylic resin, preferably at least about 5 wt %, and most preferably at least about 20 wt %, based upon 100% total weight of the organic vehicle. At the same time, the vehicle preferably comprises no more than about 50 wt % total acrylic resin, preferably no more than about 40 wt %, and most preferably no more than about 35 wt %, based upon 100% total weight of the organic vehicle. An organic vehicle having too much resin could create unwanted carbon residue and porosity during firing, but a sufficient amount of resin (i.e., at least about 0.1 wt %) is preferably used in order to provide the organic vehicle with a sufficient viscosity for application onto a substrate, as well as to wet the glass or ceramic particles. The resin may be pre-diluted in a determined amount of solvent, for example, at least about 50 wt %, and no more than about 95 wt %, based upon 100% total weight of the organic vehicle, or it may be added directly to the other components of the sealing composition. In one embodiment, the organic vehicle comprises butyl methacrylate resins, for example, isobutyl methacrylate resins or n-butyl methacrylate resins. The exemplary acrylic resins may be used alone or in combination as a mixture or blend in the sealing glass composition. In a preferred embodiment, the organic vehicle comprises a mixture of acrylic resins, for example a mixture of at least one isobutyl methacrylate resin and at least one n-butyl methacrylate resin, or a mixture of acrylic resins having different molecular weights. Where the organic vehicle comprises two different acrylic resins, the organic vehicle may comprise at least about 1 wt % of a first acrylic resin, and preferably no more than about 40 wt %, based upon 100% total weight of the vehicle. At the same time, the organic vehicle may comprise at least about 1 wt % of a second acrylic resin, and no more than about 40 wt %, based upon 100% total weight of the organic vehicle. More preferably, the organic vehicle comprises at least about 5 wt % of each resin, and more preferably at least about 10 wt %, based upon 100% total weight of the organic vehicle. At the same time, the vehicle preferably comprises no more than about 30 wt % of each resin, and most preferably no more than about 25 wt % of each resin, based upon 100% total weight of the organic vehicle. The acrylic resins in the mixture may be used at a weight ratio of about 1:10 to about 10:1, about 1:5 to about 5:1, or more preferably about 1:3 to about 3:1. In one embodiment, the acrylic resins are used in a 1:1 ratio.

The acrylic resin polymer typically has an average molecular weight of at least 10 kDa, and preferably at least 20 kDa. At the same time, the acrylic resin polymer preferably has an average molecular weight of no more than about 300 kDa, and more preferably no more than about 210 kDa. Further, acrylic resins with different glass transition temperatures (T_{g}) are also preferred.

As referenced herein, the glass transition temperature of the resin may be measured using a differential scanning calorimetry (DSC) apparatus, TA Instruments DSC Q2000 manufactured by TA Instruments-Waters LLC of New Castle, Del. For the measurements and data evaluation, the apparatus works in conjunction with TA Instruments DSC software, Version 24.9, Build 121, which records DSC and thermogravimetric analysis (TGA) curves. The instrument is equipped with a horizontal balance and furnace with a platinum/platinum-rhodium (type R) thermocouple. The sample holders used are aluminum oxide ceramic crucibles with a capacity of about 40-90 μl. As pan for reference and sample, aluminum oxide pan having a volume of about 85 μl is used. An amount of about 10-12 mg of the sample is weighted into the sample pan. The empty reference pan and the sample pan are placed in the apparatus, the oven is closed and the measurement started. A heating rate of 10 K/min is employed from a starting temperature of 23° C. to an end temperature of 150° C. The system is then equilibrated at about 150° C. for about 5 minutes. The system is then cooled from 150° C. to −30° C. at a rate of about 10° C. per minute. The system is then heated from −30° C. back to 150° C. at a rate of 10° C. per minute. The oven is then purged with nitriogen (N₂₎ with a flow rate of 50 ml/min. The first step in the DSC signal is evaluated as glass transition using the software described above, and the determined onset value is taken as the temperature for T_{g}.

One exemplary acrylic resin is an n-butyl methacrylate resin of average molecular weight 20-40 kDa, which typically has a glass transition temperature of about 40-60° C. Another exemplary acrylic resin polymer is an isobutyl methacrylate resin of average molecular weight 125-155 kDa, which typically has a T_{g} of about 15-25° C. Another further exemplary acrylic resin is an isobutyl methacrylate resin of average molecular weight 175-205 kDa, which typically has a T_{g} of about 40-60° C.

An organic vehicle containing resins with relatively higher molecular weights provides the sealing glass composition with high green strength but lower flexibility. Use of resins with relatively lower molecular weights results in sealing glass compositions with better flexibility, but lower green strength. A preferred organic vehicle contains a mixture of at least two resins which balance the resulting flexibility and green strength properties of the resulting sealing glass composition.

In a preferred embodiment, a mixture of at least two acrylic resins is used, for example, having different molecular weights and/or glass transition temperatures. In one embodiment, the organic vehicle includes an acrylic resin having a T_{g} of at least about 40° C. and no more than about 60° C., and another acrylic resin having a T_{g} of at least about 15° C. and no more than about 25° C. In another embodiment, the organic vehicle includes: (i) an n-butyl methacrylate resin having an average molecular weight of at least about 20 kDa and no more than about 40 kDa, and a T_{g} of at least about 40° C. and no more than about 60° C., and (ii) an isobutyl methacrylate resin having an average molecular weight of at least about 125 kDa and no more than about155 kDa, and a T_{g} of at least about 15° C. and no more than about 25° C. In yet another embodiment, the organic vehicle includes: (i) an isobutyl methacrylate resin having an average molecular weight of at least about 175 kDa and no more than about 205 kDa, and a T_{g} of at least about 40° C. and no more than about 60° C., and (ii) an isobutyl methacrylate resin having an average molecular weight of at least about 125 kDa and no more than about 155 kDa, and a T_{g} of at least about 15° C. and no more than about 25° C. In yet another embodiment, the organic vehicle includes at least two acrylic resins, one acrylic resin having a T_{g} of at least 40° C. and a second acrylic resin having a T_{g} of 30° C. or less. The use of a combination of acrylic resins having varying glass transition temperatures can provide the resulting sealing glass composition with suitable flexibility in its green state.

The organic vehicle also comprises solvent, which provides a number of important functions, including improving viscosity, rheology, dispensability, printability, and contact properties of the sealing glass composition. Any solvent known to one skilled in the art that is compatible with (e.g., can effectively dissolve) acrylic resins may be used. Common solvents include, but are not limited to, aromatic solvents, carbitol, terpineol, hexyl carbitol, texanol, butyl carbitol, butyl carbitol acetate, or dimethyladipate or glycol ethers. The solvent may be at least about 30 wt %, preferably at least about 35 wt %, and most preferably at least about 40 wt %, based upon 100% total weight of the vehicle. At the same time, the solvent is preferably no more than about 99 wt %, preferably no more than about 80 wt %, and most preferably no more than about 70 wt % of the vehicle, based upon 100% total weight of the vehicle. The solvent may be incorporated with the acrylic resins, or the solvent may be added directly to the sealing glass composition.

According to another embodiment, the organic vehicle may further comprise surfactant(s) and/or thixotropic agent(s). These components also contribute to the improved viscosity, printability and contact properties of the sealing composition. All surfactants which are known to the person skilled in the art, and which are considered to be suitable in the context of this invention, may be employed as the surfactant in the organic vehicle. Suitable surfactants include, but are not limited to, those based on linear chains, branched chains, aromatic chains, fluorinated chains, siloxane chains, polyether chains and combinations thereof. Surfactants include, but are not limited to, single chained, double chained or poly chained. The surfactants may be non-ionic, anionic, cationic, amphiphilic, or zwitterionic. The surfactants may be polymeric surfactants, monomeric surfactants, or any mixtures thereof. Preferred surfactants include those having pigment affinic groups, such as hydroxyfunctional carboxylic acid esters with pigment affinic groups (e.g., DISPERBYK®-108, manufactured by BYK USA, Inc.), DISPERBYK®-110 (manufactured by BYK USA, Inc.), acrylate copolymers with pigment affinic groups (e.g., DISPERBYK®-116, manufactured by BYK USA, Inc.), modified polyethers with pigment affinic groups (e.g., TEGO® DISPERS 655, manufactured by Evonik Tego Chemie GmbH), and other surfactants with groups of high pigment affinity (e.g., TEGO® DISPERS 662 C, manufactured by Evonik Tego Chemie GmbH). Other preferred surfactants include, but are not limited to, polyethylene glycol and its derivatives, alkyl carboxylic acids and their derivatives, and salts or mixtures thereof. A preferred polyethylene glycol derivative is poly (ethylene glycol) acetic acid. Preferred alkyl carboxylic acids are those with fully saturated or singly or poly unsaturated alkyl chains or mixtures thereof. Preferred carboxylic acids with saturated alkyl chains are those with alkyl chains lengths in a range from about 8 to about 20 carbon atoms, preferably C₉H₁₉COOH (capric acid), C₁₁H₂₃COOH (lauric acid), C₁₃H₂₇COOH (myristic acid) C₁₅H₃₁COOH (palmitic acid), C₁₇H₃₅COOH (stearic acid), and mixtures thereof. Preferred carboxylic acids with unsaturated alkyl chains include C₁₈H₃₄O₂ (oleic acid) and C₁₈H₃₂O₂ (linoleic acid). A preferred monomeric surfactant is benzotriazole and its derivatives. If present, the surfactant is at least about 0.01 wt %, based upon 100% total weight of the organic vehicle. At the same time, the surfactant is preferably no more than about 10 wt %, preferably no more than about 8 wt %, and more preferably no more than about 6 wt %, based upon 100% total weight of the organic vehicle.

The organic vehicle may also include one or more thixotropic agents. Thixotropic agents prevent the sealing composition from spreading when deposited onto a substrate surface, which helps in achieving desired film thickness. Any thixotropic agent known to one skilled in the art that is compatible with the solvent and resin system may be used. Preferred thixotropic agents include, but are not limited to, carboxylic acid derivatives, preferably fatty acid derivatives or combinations thereof. Preferred fatty acid derivatives include, but are not limited to, C₉H₁₉COOH (capric acid), C₁₁H₂₃COOH (lauric acid), C₁₃H₂₇COOH (myristic acid) C₁₅H₃₁COOH (palmitic acid), C₁₇H₃₅COOH (stearic acid) C₁₈H₃₄O₂ (oleic acid), C₁₈H₃₂O₂ (linoleic acid) and combinations thereof. A preferred combination comprising fatty acids in this context is castor oil. Additional preferred thixotropic agents include, but are not limited to, Thixatrol® ST, Thixatrol® PLUS, and Thixatrol® MAX (manufactured by Elementis Specialties, Inc.). These components may be incorporated with the solvent and/or solvent/resin mixture, or they may be added directly into the sealing composition. If present, the thixotropic agent is at least about 0.1 wt %, and preferably at least about 0.5 wt %, based upon 100% total weight of the sealing glass composition. At the same time, the thixotropic agent is preferably no more than about 2 wt %, and more preferably no more than about 1.5% wt %, based upon 100% total weight of the sealing glass composition.

The organic vehicle may also comprise additives which are distinct from the aforementioned organic vehicle components, and which contribute to favorable properties of the sealing glass composition, such as advantageous viscosity, dispensability, and printability. All additives known to the person skilled in the art, and which are considered to be suitable in the context of the invention, may be employed as additives in the organic vehicle. Preferred additives according to the invention include, but are not limited to, viscosity regulators, stabilizing agents, inorganic additives, thickeners, emulsifiers, dispersants, plasticizers or pH regulators.

Plasticizers are additives that increase the plasticity or fluidity of a material. Ester plasticizers may be used, which include, but are not limited to, sebacates, adipates, terephthalates, dibenzoates, gluterates, phthalates, azelates, and other blends. Phthalate plasticizers include, but are not limited to, Bis(2-ethylhexyl)phthalate (DEHP), Diisononyl phthalate (DINP), Di-n-butyl phthalate (DnBP, DBP), Butyl benzyl phthalate (BBzP), Diisodecyl phthalate (DIDP), Di-n-octyl phthalate (DOP or DnOP), Diisooctyl phthalate (DIOP), Diethyl phthalate (DEP), Diisobutyl phthalate (DIBP), Di-n-hexyl phthalate, and mixtures thereof. Trimellitates plasticizers include, but are not limited to, Trimethyl trimellitate (TMTM), Tri-(2-ethylhexyl)trimellitate (TEHTM-MG), Tri-(n-octyl,n-decyl)trimellitate (ATM), Tri-(heptyl,nonyl)trimellitate (LTM), n-octyl trimellitate (OTM), and mixtures thereof Adipate, sebacate, and maleate-based plasticizers include, but are not limited to, Bis(2-ethylhexyl)adipate (DEHA), Dimethyl adipate (DMAD), Monomethyl adipate (MMAD), Dioctyl adipate (DOA), Dibutyl sebacate (DBS), Dibutyl maleate (DBM), Diisobutyl maleate (DIBM), and any mixtures thereof. If present, the sealing glass composition may include at least about 0.01wt % plasticizers, and more preferably at least about 0.5 wt %, based upon 100% total weight of the sealing glass composition. At the same time, the composition may include no more than about 10 wt % plasticizers, and more preferably no more than about 8 wt %, based upon 100% total weight of the sealing composition.

When incorporated into a sealing composition for a fuel cell assembly, the organic vehicle may be present in an amount of at least about 1 wt %, more preferably at least about 10 wt %, and most preferably at least about 15 wt %, based upon 100% total weight of the sealing glass composition. At the same time, the vehicle may be present in an amount of no more than about 50 wt %, more preferably no more than about 40 wt %, and most preferably ano more than about 30 wt %, based upon 100% total weight of the sealing glass composition.

### Sealing Glass Composition

The sealing composition of the invention comprises glass or ceramic particles and the organic vehicle discussed herein. The glass and/or ceramic particles provide the sealing composition electrical insulation and stability at elevated operating temperatures. The sealing glass composition is typically applied between layers of fuel cell components, e.g., ceramic electrodes or electrolyte layers braised onto a metal frame. When assembled, the layered structure is typically compressed under heat and subsequently subject to high heat, i.e., firing at temperatures of at least about 800° C. and preferably no more than about 1,000° C. After firing, the sealing glass composition fuses and bonds with the fuel cell layers forming a gas tight seal. In a preferred embodiment, the sealing composition comprises fine glass powder. The sealing composition preferably comprises at least about 30 wt % powder, preferably at least about 45 wt %, and most preferably at least about 50 wt %, based upon 100% total weight of the sealing glass composition. At the same time, the sealing composition preferably comprises no more than about 95 wt %, and more preferably no more than about 90 wt %, based upon 100% total weight of the sealing glass composition. Glass and ceramic materials used for sealing compositions are known to one skilled in the art, and any suitable glass or ceramic material may be used according to the invention. Typically, considering the high operating temperature of a SOFC, sealing glasses having relatively high T_{g} (i.e., at least about 500° C. and preferably no more than about 800° C.) are considered for this application.

Sealing glasses may contain lead oxide or may be lead free. Preferably, the sealing glass is lead-free. The sealing glass may include, but is not limited to, silicon oxide, boron oxide, barium oxide, aluminum oxide, or zirconium oxide, and any other oxides known to one skilled in the art.

The sealing glass composition may also comprise other filler materials, such as refectory oxides or ceramics. The sealing composition may comprise at least about 5wt % oxides or other compounds, preferably at least about 10 wt %, and most preferably at least about 20 wt %, based upon 100% total weight of the sealing glass composition. At the same time, the sealing composition preferably comprises no more than about 50 wt % oxides or other compounds, more preferably no more than about 40 wt %, and most preferably no more than about 30 wt %, based upon 100% total weight of the sealing glass composition. Suitable oxides or compounds for use in sealing compositions are known to one skilled in the art and include, but are not limited to, oxides or other compounds of silicon, boron, aluminum, bismuth, lithium, sodium, magnesium, zinc, titanium, zirconium, or phosphorous.

The glass powder may be milled, such as in a ball mill or jet mill, until a fine powder results. Typically, the glass powder may be milled to an average particle size of at least about 1 μm, and preferably at least about 5 μm. At the same time, the average particle size may be no more than about 50 μm, and preferably no more than about 20 μm.

### Forming Sealing Glass Composition

To form a sealing glass composition, the organic vehicle is combined with the solid glass or ceramic powder, and any other additives, using any method known in the art for preparing a sealing composition. The method of preparation is not critical, as long as it results in a homogenously dispersed composition. The components can be mixed, such as with a mixer, then passed through a three roll mill, for example, to make a dispersed uniform composition.

### Application of Sealing Glass Composition to Substrate

The sealing glass composition may be applied to a fuel cell substrate in any pattern or shape that is known to one skilled in the art, as long as it forms the necessary seal between the fuel cell layers. The composition may be applied using any method known to one skilled in the art, including, but not limited to, impregnation, dipping, pouring, injection, syringe dispensing, spraying, knife coating, curtain coating, brush or printing, decal transfer, or a combination of at least two thereof. Preferred application methods are screen printing, decal transfer and syringe dispensing, or a combination thereof.

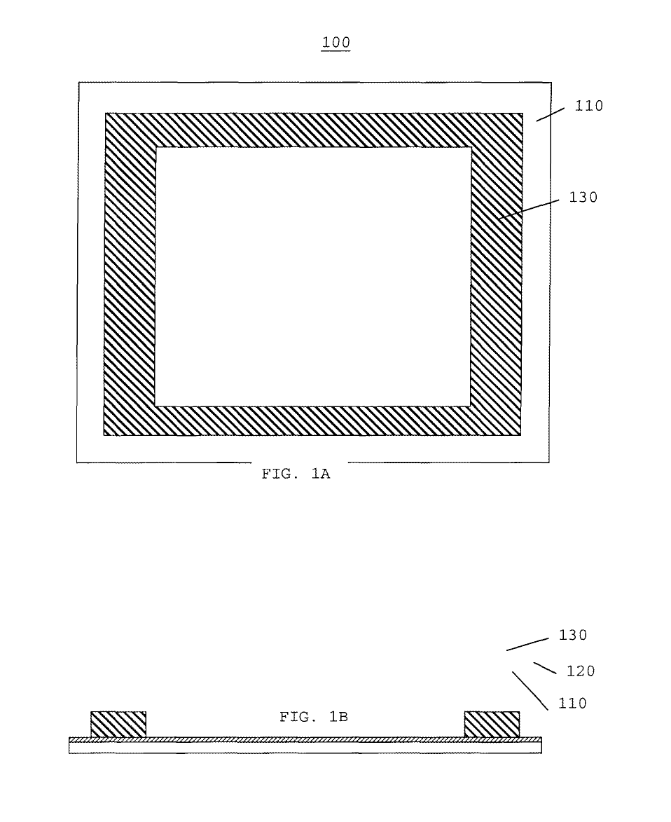

According to one embodiment, the composition may be applied to the substrate using a decal transferring technique. Using this method, the sealing glass composition is first screen printed onto the front surface of a releasable supporting sheet, such as a sheet of biaxially-oriented polyethylene terephthalate polymer (PET, commonly manufactured under the trade name Mylar®), in a desired pattern. FIGS. 1A and 1B illustrate an exemplary sealing glass composition printed in a pattern 130 on a supporting sheet 110. The supporting sheet 110 may comprise a coating of a releasing agent 120, which allows the pattern 130 to be released from the supporting sheet 110 after the pattern 130 is dried. There are a number of commercially available releasing agents known to one skilled in the art suitable for such applications. An exemplary commercially available supporting sheet with a releasing agent coating may be obtained from Saint-Gobain (TM-113, 0.003″ white PET 8752 sheet).

The sealing composition is first screen printed into the desired pattern 130 on the supporting sheet 110 on the surface coated with the releasing agent 120. To achieve the desired thickness of the pattern, the screen printing process may be repeated two or more times, printing multiple layers of the sealing glass composition on top of one another. Preferably, the thickness of the printed sealing composition pattern may be at least about 200 μm and no more than about 2 mm. In a preferred embodiment, the printed pattern is about 1 mm thick. At the same time, a printed line preferably has a width of at least about 40 μm. The width of the printed line is dependent upon the printed pattern.

It is preferred according to the invention that the screens have mesh opening of at least about 20 μm, preferably at least about 30 μm, and most preferably at least about 40 μm. At the same time, the mesh opening is preferably no more than about 100 μm, more preferably no more than about 80 μm, and most preferably no more than about 70 μm. The printed pattern may then be heated to about 80-180° C. in order to dry the sealing composition after each printing pass. Once the desired pattern and thickness are achieved, the sealing composition printed onto the supporting sheet may be further dried in order to form a decal, which may then be peeled from the supporting sheet and applied to any desired substrate.

In one embodiment, the sealing glass composition preferably has a viscosity of at least about 200 kcPs. At the same time, the sealing glass composition preferably has a viscosity of no more than about 1450 kcPs. The sealing glass composition preferably exhibits low spreading when printed onto the supporting sheet. Specifically, the printed pattern should retain its shape as much as possible and have preferably less than 10% slumping, which is defined by the increase in width of the printed line. The amount of slumping may be determined by analyzing the printed line under a microscope and measuring the increase in width of the line as it sets on the substrate. In another embodiment, the sealing glass composition has a viscosity of at least 200 kcPs, and at the same time no more than about 600 kcPs.

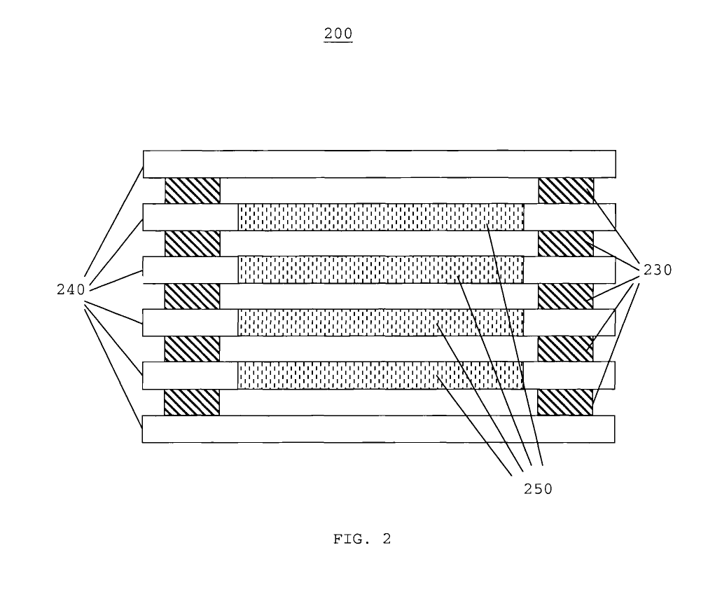

FIG. 2 illustrates an exemplary stack of alternating fuel cell layers 250 mounted on metal substrate frames 240 and sealing glass composition decals 230. A typical fuel cell layer 250 is a sandwiched structure of electrodes deposited on either side of a ceramic electrolyte layer, which is mounted on a metal frame substrate 240. The sealing glass composition decal 230 may be placed onto a first fuel cell layer 250 and metal substrate frame 240. The sealing glass composition decal 230 is then compressed against the metal substrate 240. A second fuel cell layer 250 and metal substrate may then be placed on the sealing glass composition decal 230. Another sealing glass composition decal 230 may then be placed atop the second fuel cell layer 250 and metal substrate 240. This process may be repeated until the desired number of layers is achieved. The decal transfer may be completed manually or automatically. The fuel cell layers 250, metal substrates 240, and sealing glass composition decals 230, thus form an alternating stack 200, which is then compressed under heat and fired to form a finished fuel cell assembly. Firing causes the organic vehicle of the sealing glass composition to completely or almost completely burn off, such that only the glass layer remains between the metal substrates 240.

In one embodiment, an article is formed of alternating metal substrate frames and sealing glass layers. The article includes at least two metal substrate frames, and there is preferably one more metal substrate frame than sealing layer, as referenced by the formula m=s+1, wherein m is equal to the number of metal substrate frames and s is equal to the number of sealing glass layers. In one embodiment, the article is a fuel cell.

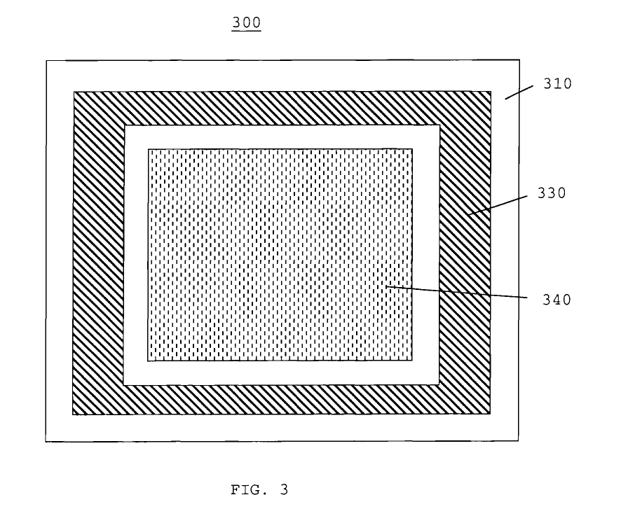

Another preferred method of applying the sealing glass composition is by dispensing, such as through a syringe or other dispensing device similar in nature. The sealing glass composition is typically loaded into a syringe and pushed through a tip or nozzle with a defined shape and size onto a metal substrate. For a sealing glass composition to be able to be applied using a syringe, the viscosity should be at least about 600 kcPs, preferably at least about 1,000 kcPs. At the same time, the viscosity should be no more than about 1,450 kcPs, preferably no more than about 1,300 kcPs. A bead of the sealing glass composition is deposited onto a fuel cell layer and metal substrate, and dried at about 80-180° C. Additional fuel cell layers and metal substrates are then sandwiched with a dried bead of sealing glass compositions between the layers. FIG. 3 illustrates an exemplary fuel cell layer 340 mounted on a metal substrate 310. Sealing glass composition 330 is dispensed according to a pattern on the metal substrate 310. The fuel layer stack is then compressed and fired to form a finished fuel cell assembly. The invention will now be described in conjunction with the following, non-limiting examples.

### EXAMPLE 1

As used in the following examples, the glass transition temperatures of the exemplary resins are set forth in Table 1 below.

TABLE 1
Glass Transition Temperatures of Exemplary Resins

| Resin | Tg (° C.) |
|---|---|
| Elvacite ® 2044 | 20 |
| Elvacite ® 2045 | 50 |
| Paraloid ™ B-67 | 50 |

A first exemplary sealing glass composition (“Composition A”) was prepared with about 21 wt % (of total sealing glass composition) of organic vehicle, about 23 wt % ball-milled fibrous oxide filler, and about 52 wt % glass frit. In addition, the composition comprised about 1 wt % of a thixotropic agent (THIXATROL® MAX, Elementis Specialties) and 3 wt % of a plasticizer (a mixture of propanol, oxybis-dibenzoate), both of which were incorporated directly into Composition A.

The organic vehicle comprised approximately 35% resin component and about 65% solvent. The resin component comprised two different acrylic resins in equal parts, such that each type of resin was about 3.7 wt % of total sealing composition. The first acrylic resin was an isobutyl methacrylate polymer resin, manufactured as Elvacite® 2044 (Lucite International). The second acrylic resin was an n-butyl methacrylate polymer resin, manufactured as PARALOID™ B-67 (The Dow Chemical Company).

The acrylic resins may be added to the sealing composition as a pre-diluted solution. For example, both acrylic resins may be dissolved in solvent and then combined with the remaining components of the sealing composition. In this particular example, both acrylic resins were pre-diluted in a texanol solvent and then combined with remaining components of Composition A.

Composition A was screen printed using a 60 mesh screen, with emulsion thickness of about 20 mil onto a supporting sheet coated with a releasing agent (Saint-Gobain, TM-113, 0.003″ white PET 8752 sheet). Two or more rounds of printing are typically required to build up the deposited sealing glass composition film to the desired thickness. In this example, the first printed layer is dried at 125° C. for 40 min, and subsequent printed layers were dried at 80° C. for 40 min. After three rounds of printing and drying the printed sealing glass composition is subject to a final drying step at 180° C. for about 15-20 min. The resulting dried sealing composition was flexible, such that it was able to be peeled from the supporting sheet as a decal without breaking, and while retaining its printed pattern and shape.

### EXAMPLE 2

A second exemplary sealing glass composition (“Composition B”) was prepared with about 21 wt % (of sealing glass composition) of organic vehicle and about 75 wt % glass fit. In addition, Composition B comprised about 1 wt % of a thixotropic agent (THIXATROL® MAX, Elementis Specialties) and 3 wt % of a plasticizer (Dibutyl phthalate, DBP), both of which were incorporated directly into Composition B. The organic vehicle contained two isobutyl methacrylate polymer resins of roughly equal parts. The first acrylic resin was about 2.5 wt % of Elvacite® 2044 (Lucite International). The second acrylic resin was about 2.5 wt % of Elvacite® 2045 (Lucite International).

Composition B was formulated and tested using syringe dispensing method. Upon visual inspection using scanning electron microscope (SEM) imaging, it was determined that the fired film resulted in a dense, uniform sealing layer.

### EXAMPLE 3

A third exemplary sealing glass composition (“Composition C”) was prepared with about 81 wt % (of sealing glass composition) of glass fit and about 19 wt % organic vehicle. The organic vehicle comprised approximately 35% resin component and about 65% solvent.

The resin component comprised two different acrylic resins. The first acrylic resin was an isobutyl methacrylate polymer resin (Elvacite® 2044). The second acrylic resin was an n-butyl methacrylate polymer resin (PARALOID™ B-67). The organic vehicle of Composition C comprised about 17.5% of the Elvacite® 2044 acrylic resin and about 17.5% of the PARALOID™ B-67 acrylic resin. In this particular example, both acrylic resins were pre-diluted in a texanol solvent and then combined with remaining components of Composition C.

The viscosity of Composition C was then tested to ensure its compatibility with a syringe application method. In this method, the composition was applied directly to the fuel cell metal substrate, in any desired pattern, by pumping it from a syringe. Composition C was applied to the metal substrate through an 18 gauge (0.033 inch) tip. The viscosity was tested using a Brookfield® DV-III HBT Ultra Programmable rheometer at a suitable speed. Specifically, the sample is measured in a 6R utility cup using a SC4-14 spindle, and the measurement is taken after one minute at 1 RPM.

Composition C exhibited a viscosity of about 1420 kcPs. When fired, the glass seal formed by Composition C exhibited good film density and low porosity when analyzed with SEM imaging.

### EXAMPLE 4

A fourth exemplary sealing glass composition (“Composition D”) was prepared with about 80 wt % (of sealing glass composition) of glass frit and about 20 wt % organic vehicle. The organic vehicle comprised approximately 26% acrylic resin and about 74% solvent. In this example, an equal amount of two isobutyl methacrylate polymer resins (Elvacite® 2044 and 2045) were used. The acrylic resin was pre-diluted in a texanol solvent and then combined with remaining components of Composition D. About 0.5 wt % of a surfactant (Byk-110) was also incorporated into the sealing glass composition.

The viscosity of Composition D was then tested to ensure its compatibility with a syringe application method, using the testing methods as set forth in Example 3. Composition D exhibited a viscosity of about 1060 kcPs, which is within the desired viscosity range. When fired, the glass seal formed by Composition D exhibited good film density and low porosity.

### EXAMPLE 5

A fifth exemplary sealing glass composition (“Composition E”) was prepared with about 81 wt % (of sealing glass composition) of glass frit and about 19 wt % organic vehicle.

The organic vehicle comprised approximately 35% resin component and about 65% solvent. The resin component comprised two different acrylic resins. The first acrylic resin was an isobutyl methacrylate polymer resin (Elvacite® 2044). The second acrylic resin was an n-butyl methacrylate polymer resin (PARALOID™ B-67). The organic vehicle of Composition E comprised about 17.5% of the Elvacite® 2044 acrylic resin and about 17.5% of the PARALOID™ B-67 acrylic resin. In this particular example, both acrylic resins were pre-diluted in a texanol solvent and then combined with remaining components of Composition E. The composition also incorporated about 0.1% surfactant (Byk-110).

The viscosity of Composition E was then tested to ensure its compatibility with a syringe application method, using the testing methods as set forth in Example 3. Composition E exhibited a viscosity of about 1230 kcPs. When fired, the glass seal formed by Composition E exhibited good film density and low porosity.

Table 2, set forth below, lists all of the exemplary compositions, their viscosity, and their performance with different processing techniques.

TABLE 2
Performance of Exemplary Pastes

| | Viscosity | | | |
|---|---|---|---|---|
| Composition | (kcPs) | Speed | Processing | Effect |
| A | 362 | 10 RPM | Decal | Dense, uniform seal |
| B | 146 | 10 RPM | Syringe | Dense, uniform seal |
| C | 1420 | 1 RPM | Syringe | Non-uniform seal |
| D | 1060 | 1 RPM | Syringe | Uniform seal with |
| | | | | some porosity |
| E | 1230 | 1 RPM | Syringe | Dense, uniform seal |

These and other advantages of the invention will be apparent to those skilled in the art from the foregoing specification. Accordingly, it will be recognized by those skilled in the art that changes or modifications may be made to the above described embodiments without departing from the broad inventive concepts of the invention. Specific dimensions of any particular embodiment are described for illustration purposes only. It should therefore be understood that this invention is not limited to the particular embodiments described herein, but is intended to include all changes and modifications that are within the scope and spirit of the invention.

1. A sealing glass composition comprising:
about 30-95 wt % glass or ceramic particles; and
about 1-50 wt % organic vehicle, wherein the organic vehicle comprises an acrylic resin component and a solvent, based upon 100% total weight of the sealing glass composition,
wherein the composition has a viscosity of at least about 200 kcPs and no more than about 1450 kcPs.

2. The sealing glass composition according to claim 1, wherein the acrylic resin component has an average molecular weight of about 20-210 kDa.

3. The sealing glass composition according to claim 1, wherein the acrylic resin component is about 0.1-50 wt %, preferably about 5-40 wt %, and most preferably about 20-35 wt %, based on 100% total weight of the organic vehicle.

4. The sealing glass composition according to claim 1, wherein the acrylic resin component comprises n-butyl methacrylate polymer resin.

5. The sealing glass composition according to claim 1, wherein the acrylic resin component comprises an n-butyl methacrylate polymer resin having an average molecular weight of about 20-40 kDa.

6. The sealing glass composition according to claim 1, wherein the acrylic resin component comprises isobutyl methacrylate polymer resin.

7. The sealing glass composition according to claim 1, wherein the acrylic resin component comprises an isobutyl methacrylate polymer resin having an average molecular weight of about 125-205 kDa.

8. The sealing glass composition according to claim 1, wherein the acrylic resin component comprises n-butyl methacrylate polymer resin and isobutyl methacrylate polymer resin.

9. The sealing glass composition according to claim 1, wherein the acrylic resin component comprises a mixture of at least two acrylic resins, one acrylic resin having a T_{g} of about 40-60° C. and a second acrylic resin having a T_{g} of about 15-25° C.

10. The sealing glass composition according to claim 9, wherein one acrylic resin is an n-butyl methacrylate resin having an average molecular weight of about 20-40 kDa and a T_{g} of about 40-60° C., and the other acrylic resin is an isobutyl methacrylate resin having an average molecular weight of about 125-155 kDa and a T_{g} of about 15-25° C.

11. The sealing glass composition according to claim 9, wherein one acrylic resin is an isobutyl methacrylate resin having an average molecular weight of about 175-205 kDa and a T_{g} of about 40-60° C., and the other acrylic resin is an isobutyl methacrylate resin having an average molecular weight of about 125-155 kDa and a T_{g} of about 15-25° C.

12. The sealing glass composition according to claim 1, wherein the solvent is about 30-99 wt %, preferably about35-80 wt %, and most preferably about 40-70 wt %, based upon 100% total weight of the organic vehicle.

13. The sealing glass composition according to claim 1, wherein the solvent is texanol or terpineol.

14. The sealing glass composition according to claim 1, further comprising a thixotropic agent.

15. The sealing glass composition according to claim 1, further comprising a plasticizer.

16. A method of applying a sealing glass composition to a substrate, comprising the steps of:
providing a supporting sheet having a front surface coated with a releasing agent;
depositing a sealing glass composition onto the front surface of the supporting sheet according to a pre-determined pattern;
drying the sealing glass composition to form a sealing glass composition decal;
removing the sealing glass composition decal from the front surface of the supporting sheet; and
placing the dried sealing glass composition decal onto a metal substrate.

17. The method of applying a sealing glass composition to a substrate according to claim 16, wherein the depositing of the sealing glass composition onto the front surface of the supporting sheet is by screen printing.

18. The method of applying a sealing glass composition to a substrate according to claim 16, further comprising the steps of:
forming an alternating assembly of metal substrates and sealing glass compositions; and
compressing the assembly.

19. The method of applying a sealing glass composition to a substrate according to claim 16, wherein the sealing glass composition comprises:
glass or ceramic particles; and
an organic vehicle including an acrylic resin component and a solvent.

20. An article comprising:
a plurality of metal substrate frames; and
a plurality of sealing glass layers,
wherein each metal substrate frame is stacked on top of each sealing glass layer to form an alternating assembly, and m=s+1 and m≧2, wherein m equals the number of the metal substrate frames and s equals the number of sealing glass layers.

21. The article according to claim 20, wherein the article is a fuel cell.
